(19) United States
(12) Patent Application Publication
(10) Pub. No.: US 2023/0051219 A1
(43) Pub. Date: Feb. 16, 2023

(54) DENTAL INSTRUMENT PRESSURE INDICATION

(71) Applicant: University of Florida Research Foundation, Inc., Gainesville, FL (US)

(72) Inventors: Hind S. Hussein, Gainesville, FL (US); Nader Farhan Abdulhameed, Gainesville, FL (US)

(21) Appl. No.: 17/759,239

(22) PCT Filed: Jan. 25, 2021
(86) PCT No.: PCT/US2021/014835

§ 371 Date: Jul. 21, 2022

Related U.S. Application Data
(60) Provisional application No. 62/967,374, filed on Jan. 29, 2020.

(51) Int. Cl. A61C 1/00; A61C 3/02; G08B 21/18

(52) U.S. Cl. CPC A61C 1/0015; A61C 3/02; G08B 21/18

(57) ABSTRACT

The disclosure relates to rotary instrument indication systems. Also disclosed herein are rotary tools including indication systems. The indication systems can include a pressure sensor that can monitor force or pressured applied through a rotary instrument. A pressure indicator can also provide a feedback indication when the monitored force or pressure reaches or exceeds a predefined threshold. In some aspects, the rotary instrument is a dental drill.

### CROSS-REFERENCE TO RELATED APPLICATIONS

This application claims the benefit of and priority to U.S. Provisional Application Ser. No. 62/967,374, having the title “DENTAL INSTRUMENT PRESSURE INDICATION”, filed on Jan. 29, 2020, the disclosure of which is incorporated herein by reference in its entirety.

### BACKGROUND

Handheld dental drills are used for different procedures, including operative procedures such as cavity preparation, for endodontic procedures such as root canal, and for bone drilling for dental implants. Each type of procedure has a different optimum pressure to successfully perform the procedure without causing damage to surrounding pulp or bone, or to prevent damage to the dental tool. Current instruments do not have pressure indicators, and as such, practitioners must rely solely on experience to determine the appropriate amount of pressure for each procedure. As a result, adverse consequences of too much pressure can include tooth breakage, pulp necrosis, tool breakage in the tooth, and excess heat causing post-operative sensitivity and/or bone necrosis, and ultimately implant failure and tooth loss.

### SUMMARY

Embodiments of the present disclosure provide rotary instrument pressure indication systems and tools using pressure indication systems.

An embodiment of the present disclosure includes a rotary instrument pressure indication system that includes a pressure sensor configured to monitor force or pressured applied through a rotary instrument and a pressure indicator configured to provide a feedback indication when the monitored force or pressured reaches or exceeds a predefined threshold.

An embodiment of the present disclosure also includes rotary tools having a pressure indication system as described above.

Other compositions, apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C illustrate an example of a rotary tool or instrument comprising a pressure sensor, in accordance with various embodiments of the present disclosure.

FIGS. 2A-2C illustrate examples of force or pressure sensors that can be used in the rotary tool or instrument of FIGS. 1A-1C, in accordance with various embodiments of the present disclosure.

FIG. 3 is a flow chart illustrating an example of a method for providing a rotary instrument pressure indication, in accordance with various embodiments of the present disclosure.

### DETAILED DESCRIPTION

Disclosed herein are various embodiments of methods related to pressure indicators with feedback for use with rotary tools or instruments (e.g., dental handpieces or dental drills), and rotary tools or instruments that include pressure indicators with physical feedback. Reference will now be made in detail to the description of the embodiments as illustrated in the drawings, wherein like reference numbers indicate like parts throughout the several views.

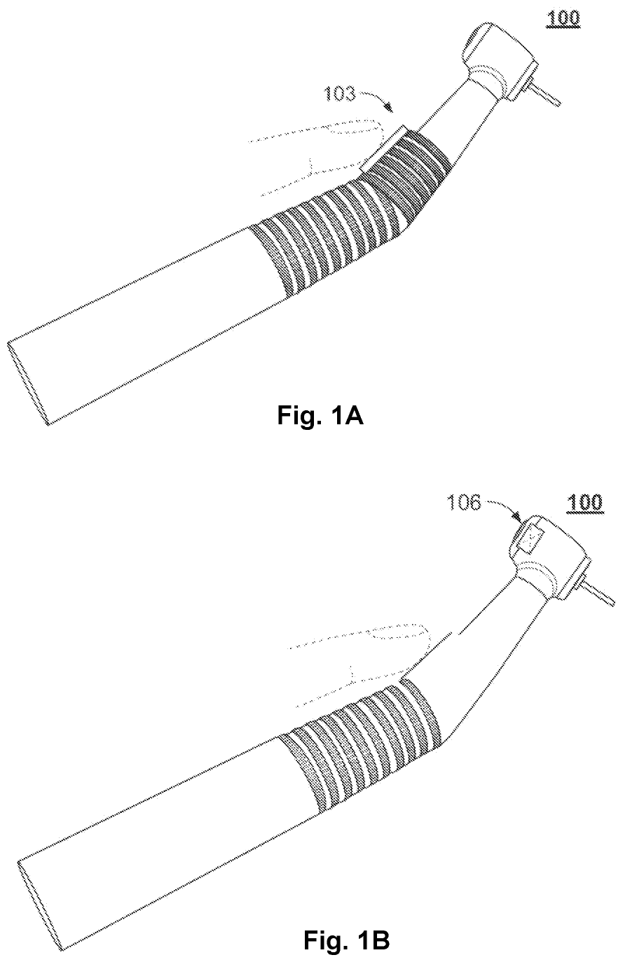

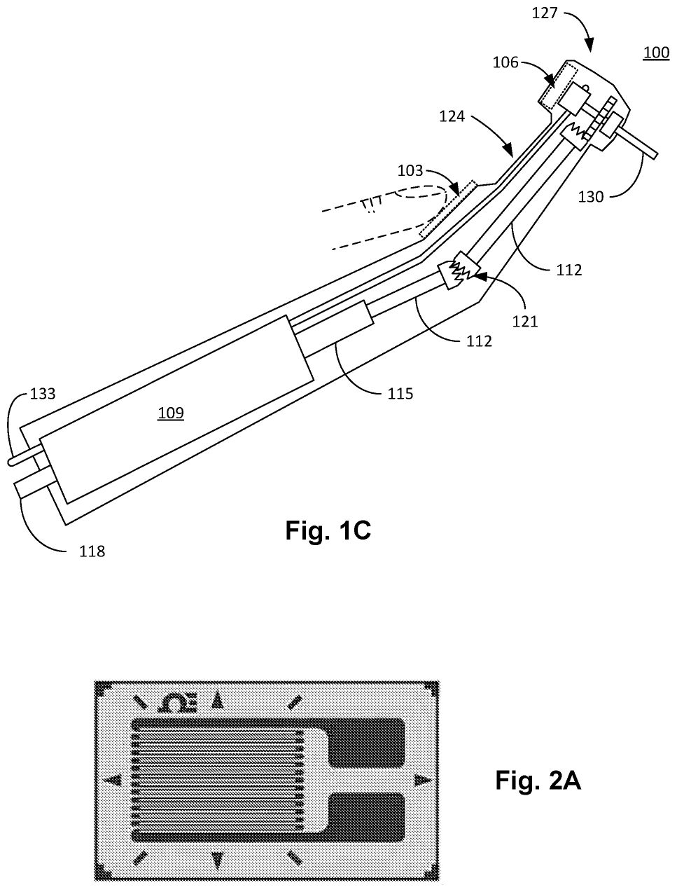

High-speed rotary cutting instruments are efficient because they allow mineralized tissues (e.g., teeth and bones) to be prepared with minimal effort. The rotary cutting instruments include handheld drills that are driven by electric or pneumatic motors in the handle of the instrument. However, if these instruments are used inappropriately, the dental pulp may be irreparably damaged. Pressure indicators such as those described herein can be used to assist dental practitioners in applying an optimal amount of pressure relative to rotary speed of the instrument in order to perform successful procedures while minimizing the risk of tissue damage or tool breakage. FIGS. 1A and 1B show an example of a rotary cutting instrument 100 (e.g., dental drill) that can include an external sensor 103 located, e.g., on the instrument body (or neck) as illustrated in FIG. 1A, where an operator would apply a force (or pressure) during use, or an internal sensor 106 in the head of the instrument as illustrated in FIG. 1B, where the drill bit, bur or file is coupled to the rotary instrument.

FIG. 1C is a schematic diagram illustrating a cross-sectional view of the rotatory cutting instrument 100 of FIGS. 1A and 1B. The body of the instrument 100 can enclose (or contain) a variety of components. An electric or pneumatic motor 109 can be in the body and coupled to a drive shaft 112 through a drive coupling 115. An electrical or air input coupling 118 located at a proximal end of the instrument 100 can be used to connect the motor 109 to its power source (e.g., through an electrical or air connection). Sections of the drive shaft 112 be connected through gears 121 (e.g., a crown-wheel gear box) to allow the drive shaft 112 to extend through the neck 124 of the body to the head 127 at the distal end of the instrument 100. The head 127 of the rotary instrument 100 can include head bearing(s), gear box and/or chuck. The shank of a drill bit, bur or file can be secured in the chuck of the rotary instrument 100 for use. Operation of the motor 109 produces rotation of the dental attachment 130 such as, e.g., drill bit, bur or file secured to the bur latch, which can produce thermal and non-thermal effects when used on a patient. Water cooling can also be provided to the head 127 of the rotary instrument 100 through a connection 133 at the proximal end of the instrument 100 to help maintain temperature within operational limits to avoid damage or injury. Other components to facilitate desired functionality can also be included in the instrument 100.

Thermal or non-thermal stimuli applied to dental structures can produce pulpal responses. Various alterations can occur by heat generation, such as tissue burning, the development of reparative dentin, postoperative sensitivity, and pulpal necrosis. Studies indicate that with temperature increases of more than 5.5° C., dental pulp could not reverse inflammation in 40% of subjects tested; an increase of 11° C. over normal temperature invariably resulted in necrosis. Dental pulp recovered its original temperature slowly when temperatures applied to the enamel surface exceeded 40° C. The 5.5° C. temperature threshold was always exceeded in the absence of air-water spray during rotary tool use.

A direct relationship exists between (a) generated heat and water flow, and (b) generated heat and the loading and cutting techniques applied. Even with cooling, high heat generation occurs with high pressure. The pressure refers to the pressure applied to a surface to be cut by a bit or file of a rotary tool. As would be understood by one of ordinary skill in the art, the pressure is a direct result of the pressure or force applied by an operator to the rotary instrument 100. Pressure, then, as used herein can refer interchangeably to pressure applied to the surface (such as a tooth surface) or pressure applied by the operator to the body of the rotary tool 100.

High-speed or pressure bone drilling can cause thermal bone necrosis, in which osteoclasts are killed and bone regeneration is significantly or completely impaired. Either the combination of low speed (600 rpm) and high force (1000 gm) or high speed (1200 rpm) and low force (500 gm) has been found to provide optimal conditions, resulting in temperatures of 40° C.-45° C., thus staying below a critical value of 50° C. In addition, mechanical failure of the drill bit, bur or file 130 attached to the rotary tool 100 can be caused by cyclic or torsional fatigue. This can be exacerbated by the application of excess force to the rotary tool during a procedure, which can result in file breakage and/or separation.

Slower rotary speeds and pressures can result in less heat generation and reduced tool breakage. However, dental practitioners must also consider the time spent per procedure in order to be efficient. Slower procedures mean fewer patients can be seen, resulting in lost revenue. The possibility of faster tooth preparation by increasing the applied force or pressure, can be limited by two factors: (1) the potential increase in the rate of heat generation (especially if insufficient water flow is used); and (2) for high-speed air-driven instruments (turbines), the relatively low torque available with a subsequent decrease in revolutions per minute (rpm).

Control over the force (or pressure) being applied to the rotary instrument 100 can be provided through feedback to the user of the tool. This can be implemented using, e.g., a force or pressure sensor (e.g., external sensor 103 and/or internal sensor 106) configured to detect the force (or pressure) applied by the user to the device during operation, and a feedback device configured to provide an indication of the amount of force being applied or when an operational threshold is reached or exceeded. The sensor 103/106 can be integrated into the rotary instrument 100 to detect the force being applied through the rotary instrument 100.

For instance, the external sensor 103 can be integrated into the body of the rotary tool 100. As illustrated in FIGS. 1A-1C, the external sensor 103 can be located where the finger or thumb of the user presses against the rotary instrument 100. In other implementations, the external sensor 103 can be secured to the body of the rotary instrument 100 in a position that allows the force applied by the user to be measured. The sensor 103 can be configured to allow for repositioning on or removal from the rotary instrument 100. In some embodiments, the external sensor 103 can be included in an attachment that can be used with or retrofitted to existing rotary tools 100. For example, the sensor 103 can include clips, straps or other fasteners that can grip the body of the instrument 100 to hold the sensor 103 in position. In some embodiments, the rotary instrument 100 and/or pressure indicator system described herein can also be autoclaved.

The internal sensor 106 can be located inside the head 127 of the rotary instrument 100 and configured to detect the force being applied through the drill bit, bur or file 130. For example, the internal sensor 106 can be positioned between the head bearing (or gear box) and casing of the head 127 where it can detect compression resulting from the force being applied through the rotary instrument 100.

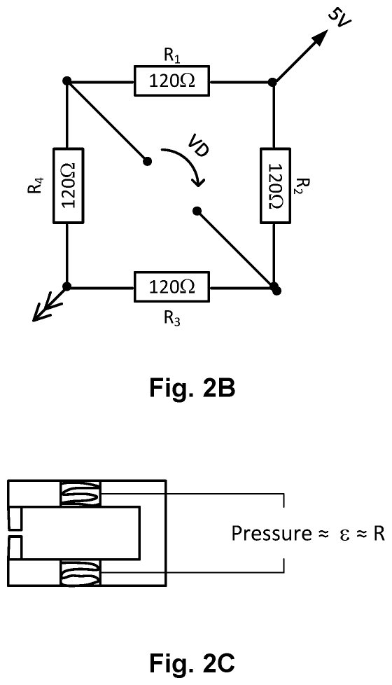

The sensor 103/106 can comprise a strain coil, strain gage, load cell or other appropriate sensing element to detect the force being applied through the rotary instrument 100. For example, the force or pressure sensor can comprise rings separated by a compressive material (e.g., springs) that can sense the compressive force that is being applied. Advantageously, the sensor 103/106 can be less than about 10 mm thick, which does not interfere with the normal position of the operator's hand when at the finger location. In other implementations, the sensor 103/106 can be a sheet strain gauge such as the example shown in FIG. 2A. Sheet strain gauges can have a thickness of about 1 mm and a length/width of about 5-10 mm, which facilitates integration into the rotary instrument 100. Typical resistances of a strain gauge include, but are not limited to, 120Ω, 350Ω, 700Ω, or 1000Ω.

Processing circuitry can be used to monitor the force (or pressure) sensor 103/106 (FIGS. 1A-1C) and configured to determine when the applied force exceeds a predefined threshold. The processing circuitry can be included as part of the rotary instrument 100 or can be remotely located from the rotary instrument 100. The processing circuitry can be communicatively coupled to the sensor 103/106. The processing circuitry can be connected to the sensor 103/106 through an electrical connection or can communicate with the sensor 103/106 through a wireless link (e.g., a Bluetooth® connection).

For example, FIG. 2B shows an example of a Wheatstone bridge that can be used to monitor a strain gauge to determine whether the amount of force applied to the rotary instrument 100 (FIGS. 1A-1C) is unacceptable. The force≈□(strain)≈resistance of the strain gauge. By utilizing the strain gauge as one of the resistances in the Wheatstone bridge, variations in the applied force affect the strain and changes the resistance of the strain gauge which produces a change in the output voltage (VD) of the Wheatstone bridge.

ΔF˜εΔ˜ΔR˜ΔVD

In the example of FIG. 2B, when the measured strain is zero (ε=0), then the grain gauge resistance is 120Ω and the bridge is balanced providing a zero output voltage (VD=0). As a force (or pressure) is applied and the strain increases (ε>0), then the strain gauge resistance increases unbalancing the bridge producing an increase in the output voltage (VD>0). The output voltage can be monitored to determine when a threshold voltage is reached or exceeded.

Temperature effects can be compensated for by including a temperature correction factor. The temperature correction factor can be determined by a function (ΔR) relating the temperature of the strain gauge to a resistance adjustment value. Thus, a corrected resistance (R_{Final}) can be adjusted by R(ε)+ΔR(T)=R_{Final}. This can be used to compensate for temperature effects in the output voltage. The temperature may be estimated based upon the applied force (or pressure) and the time during which the force is applied. In some implementations, a temperature sensor can be included in the sensor 106, the body of the rotary instrument 100, or the head 127 (FIGS. 1A-1C) to measure a temperature that can be used to estimate the correction.

FIG. 2C illustrates an example of a load cell that can be used to monitor the force or pressure applied through the rotary instrument 100 (FIGS. 1A-1C). The gap of the load cell varies with the force applied to the load cell, which affects the resistance seen at the output connection of the load cell. The force or pressure on the load cell is proportional to the strain and thus the output of the cell (Pressure˜ε˜R).

An indication of the force or pressure applied through the rotary instrument 100 can be provided to the user as feedback through a pressure indicator, which can be integrated in or attached to the rotary instrument 100 or can be remotely located from the rotary tool 100. The feedback signal provided through the pressure (or force) indicator can include, but is not limited to, visual indications (e.g., light, color or numbers), audio indications (e.g., sound or tone), tactile indications (e.g., vibration or pulsing), or combinations thereof. By utilizing a pressure indicator to provide a feedback indication to a user with respect to the operation of the rotary instrument 100, the user can be notified when the torque is reduced or when a pressure or force threshold is met or exceeded and take corrective action accordingly.

In various implementations, the operator can receive feedback when an optimal pressure or force is applied to the rotary instrument 100. In some embodiments, the operator can receive feedback when excessive pressure or force (above a defined threshold) is applied to the tool. In a non-limiting example, a light and/or an alarm sound could indicate that too much force is being applied relative to the revolutions per minute (rpm) of the tool bit. In a non-limiting example, in tools with integrated lights, the normal white light could indicate optimal force applied relative to the revolutions per minute (rpm) of the tool bit. The light could change from white to red or the light could flash to indicate that the pressure threshold has been exceeded.

The processing circuitry can monitor the force or pressure sensor 103/106 to determine when a predetermined threshold is reached or exceeded, and supply a signal to the pressure indicator to control the feedback (e.g., visual, audio, tactile, etc.) being provided to the user. The processing circuitry can comprise a processor and memory, or specifically designed hardware circuitry, configured to provide the signal in response to the sensor output with the threshold. For example, the processing circuitry can include a Wheatstone bridge as previously described.

The rotary instrument 100 can include a pressure indicator configured to provide appropriate feedback to the user regarding the force or pressure being applied through the instrument. In some implementations, the pressure indicator can be in a device separate from the rotary instrument 100. The processing circuitry can include a wireless communication interface (e.g., a WiFi, Bluetooth® or other wireless link) for communication with an external device such as, e.g., a smartphone, tablet, smart watch, computer, etc., which can provide a pressure indication to the user of the rotary instrument 100. For example, the pressor indicator can be a display that provides the visual indication (e.g., a simulated gage, bar graph, color, numbers or other appropriate visual indication) of the applied pressure or force. In some embodiments, an audio (e.g., beeping, volume, tone, etc.) or tactile (e.g., vibration, tapping, etc.) indication can be provided to the user by the pressure indicator.

In some embodiments, the rotary instrument 100, the external device or a controller such as a foot pedal or handpiece (which may include the pressure indicator) can include preset selections appropriate for specific tasks or procedures such as, but not limited to, operative (e.g., removal of carious lesions), endodontic (e.g., root canal), or implant processes. The drill speed (rpm) of the rotary tool bit or file and/or a procedure can be selected by the user, and a predetermined threshold identified based upon the selections. For example, the rotary instrument 100, external device, or controller can include input controls for selecting or adjusting the operational speed (rpm) of the drill bit, bur or file 130 (FIG. 1C). The speed may be continuously or incrementally controlled or adjusted. These input controls can be implemented through a user interface or application interface which can be executed by a smartphone, tablet, smart watch, computer, a device worn by the user of the rotary instrument or other processing device with a display.

In various embodiments, the pressure indicator can be an attachment (e.g., a removable accessory) to the rotary instrument 100 or integrated in the body of the rotary instrument. The pressure indicator can be secured or attached in a location that is readily visible to the user. For example, visual indicators can be located on the head of the rotary instrument 100 or between the head and grip of the instrument 100, where the indication can be seen by the user during operation. Pressure indicators that provide tactile feedback can be located at the grip of the rotary instrument 100 where the user can sense the tactile feedback signals through his/her hand (e.g., fingers) or can be included in the sensor 103 such that the user can sense the tactile feedback through the finger applying the force to the rotary instrument 103. Pressure indicators that provide audio feedback can be located in a location that allows the audio signal to be transmitted to the user.

As discussed, a physical feedback signal can be emitted in response to the appropriate pressure or force threshold. In a non-limiting example, at an appropriate rpm for drilling a carious lesion, the operator can receive a physical feedback signal when about 100 gm of force is exceeded. Similarly, at appropriate drill speeds for endodontic procedures, the operator would receive a physical feedback signal when about 900 gm of force is exceeded, or at about 1000 gm of force for implant procedures. In some implementations, an allowable time limit may be specified for exceeding the defined threshold. For example, the applied force or pressure detected by the system may be allowed may be allowed to exceed the threshold fora short amount of time (e.g., a second or fraction of a second) before the feedback signal is sent to the user. This can be help avoid spurious alarms that may arise as the user is adjusting operation of the rotary instrument.

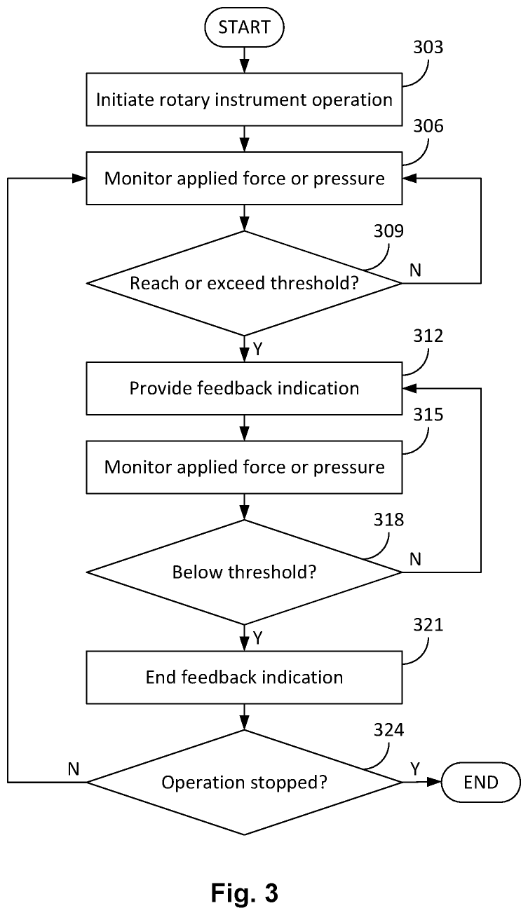

Referring next to FIG. 3, shown is a flow chart illustrating an example of the operation of the system for pressure indication. Beginning at 303, operation of the rotary instrument or tool 100 (FIGS. 1A-1C) is initiated. For example, application electrical power or pneumatic pressure to the rotary instrument 100 can initiate monitoring of the force or pressure at 306. In some implementations, turning on the system supplying the rotary instrument 100 can initiate the monitoring at 306.

At 306, the force or pressure being applied to the drill bit, bur or file 130 (FIG. 1C) through the rotary instrument 100 by monitoring the external and/or internal sensors 103/106. The force or pressure sensor 103/106 can be monitored by processing circuitry as previously discussed. The outputs can correspond to the amount of force or pressure being applied through the drill bit, bur or file 130. The output can be compared (e.g., periodically) by the processing circuitry to one or more thresholds to determine if the applied force or pressure meets or exceeds an allowable limit.

If the threshold is not reached or exceeded at 309, then the process continues to monitor the applied force or pressure at 306 and compare the monitored condition to the one or more thresholds at 309. If a threshold is reached or exceeded at 309, then a feedback indication is provided at 312 to inform that user of the rotary instrument 100 of the operating condition. The feedback indication can be a visual, audio, tactile or other appropriate signal as previously discussed. The indication can be provided through a pressure indicator attached to or incorporated in the rotary instrument 100 or can be provided through an external device or controller. The process continues to monitor the applied force or pressure at 315 and compare the monitored condition to the one or more thresholds at 318.

If the indication does not fall below the threshold at 318, then the process continues to provide the feedback indication at 312 and monitor the applied force of pressure at 315. If the monitored level falls below the threshold at 318, then the feedback indication ends at 321. In some implementations, feedback indications can be provided for different levels of force or pressure. As the monitored level changes, it can be compared to other thresholds which, if reached or exceeded, can cause the feedback indication to be updated to correspond to the current applied force or pressure. As the monitored level falls below the threshold, the feedback indication can be updated accordingly.

If operation of the rotary instrument 100 has stopped at 324, then the process ends. Otherwise, if the user continues to operate the rotary instrument 100 at 324, then the process returns to 306 where monitoring of the applied force or pressure continues.

The flow chart of FIG. 3 should be understood as representing an example of the process, and alternate implementations are included within the scope of the present disclosure in which functions may be executed out of order from that shown or discussed, including substantially concurrently or in reverse order. In addition, the scope of the certain embodiments of the present disclosure includes embodying the functionality of the preferred embodiments of the present disclosure in logic embodied in hardware or software-configured mediums.

The rotary instrument can include a control system having processing circuitry to receive a signal from the force or pressure sensor and to trigger the physical feedback indication. In some embodiments, the processing circuitry can also receive one or more secondary input from the rotary instrument such as, e.g., rpm of the file, or temperature information. The threshold compared to the force or pressure indication from the sensor 103/106 may be dependent upon the one or more secondary input. For example, at a lower operating speed (rpm), a higher threshold can be used for comparison before triggering the physical feedback. At a higher speed (rpm), a lower threshold can be used to trigger physical feedback to account for the additional heating produced at the higher rpm.

In various embodiments, a variable speed controller (e.g. a trigger, slider, switch) can be used to adjust the operation speed of the rotary instrument. The threshold used for comparison can be based upon the speed indication, such that the feedback indication is determined based upon the amount of pressure applied at a specific speed. For example, when a procedure, such as drilling a carious lesions, requiring high speed (about 100,000-200,000 rpm) and for deep caries removal requiring low speed (about 1000-6000 rpm) is performed, the feedback threshold can be set at about 100 gm of pressure. At low speed operation (about 600 rpm), such as for implants, the threshold level can be as high as 1000 gm.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

### ASPECTS

The following list of exemplary aspects supports and is supported by the disclosure provided herein.
Aspect 1. A rotary instrument indication system, comprising:
a pressure sensor configured to monitor force or pressured applied through a rotary instrument; and
a pressure indicator configured to provide a feedback indication when the monitored force or pressure reaches or exceeds a predefined threshold.
Aspect 2. The system of aspect 1, wherein the pressure sensor comprises a strain coil, a strain gauge, and a load cell.
Aspect 3. The system of any of aspects 1-2, wherein the feedback indication comprises a visual indication, an audio indication, a tactile indication, or a combination thereof.
Aspect 4. The system of any of aspects 1-3, wherein the feedback indication is controlled by a control unit in communication with the pressure sensor, and wherein the predefined threshold is determined based upon at least one secondary input received by the control unit.
Aspect 5. The system of aspect 4, wherein the secondary input is operating speed of the rotary instrument.
Aspect 6. The system of any of aspects 1-5, wherein the pressure sensor is located at a position on the rotary instrument that aligns with a finger or thumb of the user when using the rotary tool, and the pressure sensor measures the force or pressure applied by the user's finger or thumb to the rotary instrument.
Aspect 7. The system of any of aspects 1-5, wherein the pressure sensor is located in a head of the rotary instrument, and the pressure sensor measures the force or pressure applied through a dental attachment affixed to the rotary instrument.
Aspect 8. The system of any of aspects 1-7, wherein the predefined threshold corresponds to a force in a range from about 100 gm to about 1 kg.
Aspect 9. The system of any of aspects 1-8, wherein the pressure sensor is configured to detachably attach to the rotary instrument.
Aspect 10. The system of any of aspects 1-9, wherein the pressure indicator is integrated with the pressure sensor.
Aspect 11. The system of any of aspects 1-8, wherein the pressure sensor and the pressure indicator are integrated into a body of the rotary instrument.
Aspect 12. The system of any of aspects 1-9, wherein the pressure indicator is separate from the rotary instrument.
Aspect 13. The system of aspect 12, wherein a device worn by a user of the rotary device comprises the pressure indicator.
Aspect 14. The system of aspect 13, wherein the device is a smart watch that provides the feedback indication, where the feedback indication comprises a visual indication, an audio indication, a tactile indication, or a combination thereof.
Aspect 15. A rotary instrument, comprising:
a pressure sensor configured to monitor force or pressured applied through a rotary instrument; and
a pressure indicator configured to provide a feedback indication when the monitored force or pressure reaches or exceeds a predefined threshold.
Aspect 16. The rotary instrument of aspect 15, wherein the pressure sensor comprises a strain coil, a strain gauge, and a load cell.
Aspect 17. The rotary instrument of any of aspects 15-16, wherein the feedback indication comprises a visual indication, an audio indication, a tactile indication, or a combination thereof.
Aspect 18. The rotary instrument of aspect 17, wherein the feedback signal is controlled by a control unit in communication with the pressure sensor, and wherein the predefined threshold is determined based upon at least one secondary input received by the control unit.
Aspect 19. The rotary instrument of aspect 18, wherein the secondary input is operating speed of the rotary instrument.
Aspect 20. The rotary instrument of any of aspects 15-19, wherein the pressure sensor is located at a position on the rotary instrument that aligns with a finger or thumb of the user when using the rotary tool, and the pressure sensor measures the force or pressure applied by the user's finger or thumb to the rotary instrument.
Aspect 21. The rotary instrument of any of aspects 15-19, wherein the pressure sensor is located in a head of the rotary instrument, and the pressure sensor measures the force or pressure applied through a dental attachment affixed to the rotary instrument.
Aspect 22 The rotary instrument of aspect 15, wherein the predefined threshold corresponds to a force in a range from about 100 gm to about 1 kg.
Aspect 23. The rotary instrument of any of aspects 15-23, wherein the pressure indicator is integrated with the pressure sensor.
Aspect 24. The rotary instrument of aspect 15, wherein the pressure sensor and the pressure indicator are integrated into a body of the rotary instrument.
Aspect 25. The rotary instrument of aspect 15, wherein the pressure indicator is separate from the rotary instrument.
Aspect 26. The rotary instrument of aspect 25, wherein a device worn by a user of the rotary device comprises the pressure indicator.
Aspect 27. The rotary instrument of aspect 26, wherein the device is a smart watch that provides the feedback indication, where the feedback indication comprises a visual indication, an audio indication, a tactile indication, or a combination thereof.
Aspect 28. The rotary instrument of any of aspects 15-28, wherein the operating speed can be selected by the user, and wherein the selection determines the predetermined threshold.

### REFERENCES

Bruno Neves Cavalcanti, Choyu Otani, Sigmar Mello Rode (2002) High-speed cavity preparation techniques with different water flows. The Journal of Prosthetic Dentistry, Volume 87, Issue 2, Pages 158-161, ISSN 0022-3913.
Nam O H, Yu W J, Choi M Y, Kyung H M (2006) Monitoring of bone temperature during osseous preparation for orthodontic micro-screw implants: effect of motor speed and pressure. https://www.scientific.net/KEM.321-323.1044 Key Eng Mater. 2006; 321:1044-1047.

1. A rotary instrument indication system, comprising:
a pressure sensor configured to monitor force or pressure applied through a rotary instrument; and
a pressure indicator configured to provide a feedback indication when the monitored force or pressure reaches or exceeds a predefined threshold.

2. The system of claim 1, wherein the pressure sensor comprises a strain coil, a strain gauge, and a load cell.

3. The system of claim 1, wherein the feedback indication comprises a visual indication, an audio indication, a tactile indication, or a combination thereof.

4. The system of any of claim 1, wherein the feedback indication is controlled by a control unit in communication with the pressure sensor, and wherein the predefined threshold is determined based upon at least one secondary input received by the control unit.

5. The system of claim 4, wherein the secondary input is an operating speed of the rotary instrument.

6. The system of claim 1, wherein the pressure sensor measures the force or pressure applied to the rotary instrument, wherein the force or pressure is applied to the rotary instrument by a user or applied through a dental attachment affixed to the rotary instrument.

7. (canceled)

8. The system of claim 1, wherein the predefined threshold corresponds to a force in a range from about 100 gm to about 1 kg.

9. The system of claim 1, wherein the pressure sensor is configured to detachably attach to the rotary instrument.

10. The system of claim 1, wherein the pressure indicator is integrated with the pressure sensor.

11. The system of claim 1, wherein the pressure sensor and the pressure indicator are integrated into a body of the rotary instrument.

12. The system of claim 1, wherein the pressure indicator is separate from the rotary instrument.

13. The system of claim 12, wherein a device worn by a user of the rotary device comprises the pressure indicator.

14. (canceled)

15. A rotary instrument, comprising:
a pressure sensor configured to monitor force or pressured applied through a rotary instrument; and
a pressure indicator configured to provide a feedback indication when the monitored force or pressure reaches or exceeds a predefined threshold, the feedback indication comprising a visual indication, an audio indication, a tactile indication, or a combination thereof.

16. The rotary instrument of claim 15, wherein the pressure sensor comprises a strain coil, a strain gauge, and a load cell.

17. (canceled)

18. The rotary instrument of claim 15, wherein the feedback signal is controlled by a control unit in communication with the pressure sensor;
wherein the predefined threshold is determined based upon at least one secondary input received by the control unit
wherein the secondary input is an operating speed of the rotary instrument;
wherein the operating speed can be selected by a user;
and wherein the selection determines the predetermined threshold.

19. (canceled)

20. The rotary instrument of claim 15, wherein the pressure sensor is located at a position on the rotary instrument that aligns with a finger or thumb of the user when using the rotary tool, and the pressure sensor measures the force or pressure applied by a user's finger or thumb to the rotary instrument.

21. The rotary instrument of claim 15, wherein the pressure sensor is located in a head of the rotary instrument, and the pressure sensor measures the force or pressure applied through an attachment affixed to the rotary instrument. (Original) The rotary instrument of claim 15, wherein the predefined threshold corresponds to a force in a range from about 100 gm to about 1 kg.

23. The rotary instrument of claim 15, wherein the pressure indicator is integrated with the pressure sensor.

24. The rotary instrument of claim 15, wherein the pressure sensor and the pressure indicator are integrated into a body of the rotary instrument.

25-28. (canceled)
